(19) United States
(12) Patent Application Publication
(10) Pub. No.: US 2014/0291591 A1
(43) Pub. Date: Oct. 2, 2014

(54) NANOCOMPOSITE STRUCTURE, ELECTRODE INCLUDING THE NANOCOMPOSITE STRUCTURE, MANUFACTURING METHOD OF THE ELECTRODE, AND ELECTROCHEMICAL DEVICE INCLUDING THE ELECTRODE

(71) Applicant: Intellectual Discovery Co., Ltd., Seoul (KR)

(72) Inventors: Hyeong tag Jeon, Seoul (KR); Seokyoon Shin, Goyang-si (KR); Hagyoung Choi, Seoul (KR); Giyul Ham, Seoul (KR)

(73) Assignee: Intellectual Discovery Co., Ltd., Seoul (KR)

(21) Appl. No.: 14/158,185

(22) Filed: Jan. 17, 2014

(30) Foreign Application Priority Data
Mar. 28, 2013 (KR) 10-2013-0033835

(51) Int. Cl. H01G 9/20; H01M 4/04

(52) U.S. Cl. CPC H01G 9/2031; H01M 4/0428
USPC 252/520.2; 427/126.3; 427/576; 427/126.5; 427/108; 427/125; 427/123

(57) ABSTRACT

A nanocomposite structure, including: TiO₂ nanotubes; and nanoparticles uniformly formed on surfaces of the TiO₂ nanotubes.

### CROSS-REFERENCE TO RELATED APPLICATION

This application claims priority to and the benefit of Korean Patent Application No. 10-2013-0033835 filed in the Korean Intellectual Property Office on Mar. 28, 2013, the entire contents of which are incorporated herein by reference.

### BACKGROUND OF THE INVENTION

1. Field of the Invention

A nanocomposite structure, an electrode including the nanocomposite structure, a manufacturing method of the electrode, and an electrochemical device including the electrode are provided.

2. Description of the Related Art

Titanium dioxide receives more attention as a material for a photoanode of a dye-sensitized solar cell as compared with zinc oxide (ZnO) and tin dioxide (SnO₂) since it is combinable with various dye-sensitizers and has relatively fewer surface states.

Recently, one-dimensional structured materials, such as nanofibers, nanotubes, and nanowires, have been applied for a photoanode of a dye-sensitized solar cell. Particularly, vertically grown titanium dioxide nanotubes have shown excellent electron mobility and ion mobility to improve the photocurrent and open circuit voltage, and thus, have been widely studied.

Most titanium dioxide nanotubes are possible to be synthesized by an electrochemical oxidation method using a titanium foil. This method can easily control the morphology of nanotubes having excellent crystallinity and self-aligning property.

However, the thus manufactured titanium dioxide nanotubes may have a decreased internal surface area due to the formation of a soft wall thereof, which restricts the efficiency in dye adsorption and the current density of a dye-sensitized solar cell.

In order to solve the problem such as a decrease in internal surface area, there have been attempts to form nanoparticles on the internal surface or modify the internal surface. The thus formed nanotubes have advantages and disadvantages according to the morphology and crystal structure thereof.

For example, when nanoparticles are formed on internal surfaces of nanotubes through a titanium tetrachloride (TiCl₄) treatment, the open circuit voltage may be reduced due to an increase in recombination at an interface between the nanoparticles and an electrolyte. Moreover, when nanoparticles are formed through modification of internal surfaces of nanotubes, charge transfer characteristics may be deteriorated.

Therefore, research on the improvement of surface characteristics of nanotubes, without the deterioration of charge transfer characteristics, is needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

An embodiment provides a nanocomposite structure, including: TiO₂ nanotube,; and nanoparticles uniformly formed on wall surfaces of the TiO₂ nanotubes.

The nanoparticles may include a metal or a metal oxide.

The nanoparticles may include titanium (Ti), titanium oxide, silver (Ag), silver oxide, gold (Au), gold oxide, platinum (Pt), platinum oxide, or a combination thereof.

The average outer diameter of the TiO₂ nanotubes may be from 10 to 1000 nm.

The average wall thickness of the TiO₂ nanotubes may be 0.1 to 100 nm.

An embodiment provides an electrode including the nanocomposite structure.

An embodiment provides an electrochemical device including the electrode.

An embodiment provides a manufacturing method of an electrode, the method including: preparing amorphous TiO₂ nanotubes by anodizing a Ti substrate; crystallizing the amorphous TiO₂ nanotubes through a heat treatment; bonding the crystallized TiO₂ nanotubes to a substrate; and forming a coating layer on wall surface of the crystallized TiO₂ nanotubes through atomic layer deposition (ALD), the coating layer containing metal or metal oxide; and subjecting the coated nanotubes to a water treatment.

The crystallizing of the amorphous TiO₂ nanotubes through heat treatment may be performed at a temperature of from 200 to 800° C.

The substrate may be a transparent conductive oxide (TCO) substrate, a silicon substrate, a plastic substrate, a glass substrate, a metal substrate, a quartz substrate, a metal oxide substrate, a metal nitride substrate, or a combination thereof.

The atomic layer deposition (ALD) may be remote plasma atomic layer deposition (RPALD).

The atomic layer deposition (ALD) may be performed by using a metal precursor or a metal oxide precursor; and plasma.

The atomic layer deposition (ALD) may be remote plasma atomic layer deposition (RPALD) using titanium tetraisopropoxide [Ti(OC(CH₃)₂)₄] as a metal precursor and O₂ plasma as a reactant.

The atomic layer deposition (ALD) may be performed at a temperature of 70 to 150° C.

In the forming of the coating layer, the metal may be titanium (Ti), silver (Ag), gold (Au), platinum (Pt), or a combination thereof, and the metal oxide is titanium oxide, silver oxide, gold oxide, platinum oxide, or a combination thereof.

The thickness of the coating layer may be from 1 to 50 nm.

The coating layer may be converted into nanoparticles through the water treatment of the nanotubes with the coating layer formed thereon.

The water treatment may be performed for from 10 to 100 hours.

Specific descriptions of other embodiments are included in the following detailed description.

According to an embodiment, the nanocomposite structure can induce efficient dye adsorption and charge transfer, and the electrode including the nanocomposite structure and the electrochemical device including the electrode can have improved photo conversion efficiency.

### BRIEF DESCRIPTION OF THE DRAWINGS

FIG. 1 is a diagram schematically showing a manufacturing method of an electrode according to an embodiment;

FIG. 2 is an XRD analysis graph of a crystalline anatase TiO₂ nanotube array before forming an ALD coating layer in Example 1;

FIG. 3 is a SEM image of a crystalline anatase TiO₂ nanotube array before forming an ALD coating layer in Example 1;

FIG. 4 is an SEM cross-sectional image of a crystalline anatase TiO₂ nanotube array before forming an ALD coating layer in Example 1;

FIG. 5(a) is an HR-SEM image of a TiO₂ nanotube array after ALD coating before water treatment in Example 1;

FIG. 5(b) is an HR-SEM image of the ALD-coated TiO₂ nanotube array after water treatment for 24 hours in Example 1;

FIG. 5(c) is a high resolution-transmission electron microscopy (HR-TEM) image of a TiO₂ nanotube array after ALD coating before water treatment in Example 1;

FIG. 5(d) is an enlarged image of a circle part of FIG. 5(c);

FIG. 5(e) is an HR-TEM image of a nanotube after water treatment for 48 hours in Example 2; FIG. 5(f) is an enlarged image of a circled part of FIG. 5(e);

FIG. 6 is an HR-SEM image of nanotubes after water treatment for 48 hours in Example 2;

FIG. 7 depicts J-V plots of Example 1, Example 2, and Comparative Example 1; and

FIG. 8 depicts incident photon-to-current efficiency (IPCE) spectra of Example 1, Example 2, and Comparative Example 1.

### DETAILED DESCRIPTION OF THE EMBODIMENTS

Hereinafter, embodiments will be described in detail. However, these embodiments are merely exemplified, and the scope of protection is not limited thereto but defined by the appended claims.

In an embodiment, a nanocomposite structure including TiO₂ nanotubes and nanoparticles uniformly formed on wall surface of the TiO₂ nanotubes is provided.

The nanocomposite structure may have a form in which several TiO₂ nanotubes are densely formed in parallel with each other and several nanoparticles are uniformly formed on wall surface of the TiO₂ nanotubes.

The nanocomposite structure can induce efficient dye adsorption and charge transfer, and the electrode including the nanocomposite structure and the electrochemical device including the electrode can having improved photo conversion efficiency.

The nanoparticles may include a metal or a metal oxide. The nanoparticles may include titanium (Ti) or titanium oxide. In addition, the nanoparticles may optionally further include silver (Ag), silver oxide, gold (Au), gold oxide, platinum (Pt), platinum oxide, or a combination thereof. For example, the nanoparticles may be TiO₂ nanoparticles.

The average outer diameter of the TiO₂ nanotubes may be from 10 to 1000 nm. The average outer diameter thereof may be from 10 to 800 nm, 10 to 600 nm, 10 to 400 nm, 10 to 200 nm, 10 to 150 nm, 50 to 150 nm, or 90 to 110 nm. When the average outer diameter falls within the above range, the nanocomposite structure can exhibit excellent performance when being applied to an electrode of an electrochemical device.

The average wall thickness of the TiO₂ nanotubes may be 0.1 to 100 nm. The average wall thickness thereof may be 0.1 to 80 nm, 0.1 to 60 nm, 0.1 to 40 nm, 0.1 to 20 nm, 0.1 to 10 nm, 1 to 10 nm, or 5 to 7 nm. When the average wall thickness falls within the above range, the nanocomposite structure can exhibit excellent performance when being applied to an electrode of an electrochemical device.

The existing method of forming nanoparticles inside the nanotubes by subjecting titanium dioxide nanotubes to water treatment has disadvantages in that the nanotubes become thinner due to the water treatment, thus original shapes thereof may be lost and the thicknesses thereof is difficult to control. However, according to the nanocomposite structure of an embodiment, the thicknesses of the nanotubes can be maintained within the above range and the thicknesses thereof can be controlled.

According to an embodiment, an electrode including the nanocomposite structure is provided.

The electrode has a form in which several TiO₂ nanotubes are densely formed in parallel with each other on a substrate, and several nanoparticles are uniformly formed on wall surfaces of the TiO₂ nanotubes.

According to an embodiment, a manufacturing method of the electrode is provided.

The manufacturing method of the electrode includes: preparing amorphous TiO₂ nanotubes by anodizing a Ti substrate; crystallizing the amorphous TiO₂ nanotubes through heat treatment; bonding the crystallized TiO₂ nanotubes on a substrate; forming a coating layer on wall surface of the crystallized TiO₂ nanotubes through atomic layer deposition (ALD), the coating layer containing a metal or a metal oxide; and subjecting the nanotubes with the coating layer formed thereon to water treatment.

The thus manufactured electrode can induce efficient dye adsorption and charge transfer, and the electrochemical device including the same can realize excellent photo conversion efficiency.

The Ti substrate may be a Ti foil.

In the preparing of the amorphous TiO₂ nanotubes, the anodizing may be performed by a general anodizing method that can be used in the art. The anodizing may be performed by potentiostatic anodization using a cell having two electrodes.

The anodizing may be performed by using an electrolyte containing NH₄F and ethylene glycol.

For example, in the preparing of the amorphous TiO₂ nanotubes, the Ti substrate is washed, anodized at 10 to 100 V for 1 to 3 hours, subjected to ultrasonic treatment while being immersed in an oxidizing solution of H₂O₂, and then washed.

In addition, the anodizing may be performed twice or more.

The anodizing may be performed by a double anodization method to suppress the formation of nanograss. For example, the Ti substrate is anodized at 10 to 100 V for 1 to 3 hours, subjected to ultrasonic treatment in an oxidizing solution of H₂O₂ or the like, anodized while being immersed in an electrolytic solution, subjected to ultrasonic treatment in a solution of isopropanol or the like, and then dried.

The preparing of the amorphous TiO₂ nanotubes may be performed at room temperature.

The crystallizing of the amorphous TiO₂ nanotubes through heat treatment may be performed at a temperature of from 200 to 800° C. The crystallizing may be performed at from 300 to 700° C., 400 to 600° C., or 400 to 500° C. When the heat treatment is performed within the above temperature range, the amorphous TiO₂ can be sufficiently crystallized.

The heat treatment may be performed while the temperature is slowly raised.

The heat treatment may be performed for 1 to 5 hours.

The nanotubes crystallized through the heat treatment may be anodized again.

The bonding of the TiO₂ nanotubes to the substrate may be performed by separating the crystallized TiO₂ nanotubes, transferring the separated TiO₂ nanotubes to the substrate, and bonding the TiO₂ nanotubes to the substrate, in that order.

The separating of the crystallized TiO₂ nanotubes may be performed by, for example, dissolving the crystallized TiO₂ nanotubes in an oxidizing solution of H₂O₂ or the like.

The bonding of the TiO₂ nanotubes to the substrate may be performed by, for example, dripping a titanium alkyl oxide solution on the substrate and then fixing the TiO₂ nanotubes to the substrate, followed by heating at 100 to 600° C.

The substrate may be a transparent conductive oxide (TCO) substrate, a silicon substrate, a plastic substrate, a glass substrate, a metal substrate, a quartz substrate, a metal oxide substrate, a metal nitride substrate, or a combination thereof.

The ALD may be one that can be generally employed in the art.

The ALD may be performed at least once, and may be performed once or more but 70 times or less.

The ALD may be, for example, remote plasma ALD (RPALD).

The ALD may be performed by using a metal precursor or a metal oxide precursor, and plasma. The metal may be titanium (Ti), silver (Ag), gold (Au), platinum (Pt), or a combination thereof, and the metal oxide may be titanium oxide, silver oxide, gold oxide, platinum oxide, or a combination thereof.

Examples of the metal precursor or metal oxide precursor may include alkyl oxides of the above metals.

An example of the plasma may be O₂ plasma.

The ALD may be performed at a temperature of from 70 to 150° C.

The coating layer formed by the ALD may have a thickness of 1 to 50 nm. The thickness thereof may be 1 to 40 nm, 1 to 30 nm, or 1 to 20 nm. The coating layer may have a layered type. According to the ALD, a coating layer with a very uniform thickness may be formed on the wall surfaces of the nanotubes.

Here, in the subjecting of the nanotubes with the coating layer to water treatment may be performed by immersing the nanotubes with the coating layer in water.

The water treatment may be performed for 10 to 100 hours. The water treatment may be performed for 10 to 50 h or 20 to 50 hours.

Through the subjecting of the nanotubes with the coating layer to water treatment, the coating layer may be converted into nanoparticles.

The existing method of forming nanoparticles inside nanotubes by subjecting titanium dioxide nanotubes to water treatment has disadvantages in that the nanotubes becomes thinner due to the water treatment, thus original shapes thereof may be lost and the thickness thereof is difficult to control.

However, according to the manufacturing method of an electrode of an embodiment, since the water treatment is performed after the coating layer is formed on the surfaces of the nanotubes by an ALD, the basic frame of the nanotubes is maintained, so that the thickness of the nanotubes can be maintained at a predetermined level and the thickness of the nanotubes can be controlled. Accordingly, a nanocomposite structure having a form in which nanoparticles are formed on wall surface of nanotubes and a shape of the nanotubes is maintained intact can be manufactured. Also, an electrode including the nanocomposite structure and a substrate can be provided.

Further, nanoparticles are difficult to form on surface of the nanotubes according to the existing method, in which nanoparticles are directly injected, but the nanoparticles can be very uniformly introduced to the wall surfaces of the nanotubes according to an embodiment.

According to an embodiment, an electrode manufactured by the above method is provided.

In the electrode, TiO₂ nanotubes are densely packed and vertically parallel with each other on a base, and nanoparticles are uniformly formed on wall surfaces of the nanotubes.

According to an embodiment, an electrochemical device including the electrode is provided.

The electrochemical device includes a display device, an energy device, and the like. Examples of the electrochemical device include a light emitting diode (LED), an organic light emitting diode (OLED), an optical sensor, a transistor, a solar cell, a fuel cell, a photocatalytic device, a photo detection device, a photoelectrochemical water splitting device, and the like. For example, the electrochemical device may be a dye-synthesized solar cell.

An embodiment has been made in an effort to provide a nanocomposite structure, an electrode, and a manufacturing method of the electrode, having advantages of inducing efficient dye adsorption and charge transfer.

An embodiment has been also made in an effort to provide an electrochemical device having advantages of having excellent photo conversion efficiency.

Hereinafter, examples and comparative examples of the present invention will be described. However, the following examples are merely for illustrating the present invention, but the present invention is not limited thereto.

### EXAMPLE 1

Preparing nanotubes by anodizing Ti substrate

A highly arranged TiO₂ nanotube array was prepared by potentiostatic anodization using a cell having two electrodes. Ti foil (0.127 mm, purity 99.7%, Aldrich) was used as an electrode and Pt gauze was used as counter electrode. Prior to anodization, the Ti foil was washed by ultrasonic treatment in an acetone, isopropanol, or ethanol solvent. Then, the Ti foil was washed with deionized (DI) water and then dried with nitrogen steam. The two electrodes were disposed at an interval of 1.5 cm, and 0.5 wt % of NH₄F (Aldrich, purity: 99.8%) and ethylene glycol (Aldrich, purity: 99.9%) were used as an electrolyte.

A double anodization method was employed to prevent the formation of nanograss. First, the Ti foil was anodized at 50 V for 2 hours, subjected to ultrasonic treatment while being immersed in a 30% solution of H₂O₂ (Aldrich), washed with DI water, and then dried. Then, the Ti foil was anodized at 50 V for 3 hours, while being immersed in the electrolyte, and subjected to ultrasonic treatment for 15 min while being immersed in isopropanol, followed by drying in air. The two anodizing processes were performed at room temperature while stifling was continuously and slowly conducted.

Crystallizing Nanotubes through Heat Treatment

In order to crystallize the amorphous TiO₂ nanotubes array formed on the Ti foil, heat treatment was performed thereon at 450° C. for 3 hours while the temperature was raised at a rate of 2° C./min. The heat-treated Ti foil and amorphous TiO₂ nanotube array were again anodized at 50 V for 30 min, and then immersed in a 30% solution of H₂O₂ (Aldrich).

Bonding Nanotubes to Substrate

The amorphous TiO₂ layer formed through anodization after heat treatment was dissolved in H₂O₂ to separate a crystalline white TiO₂ nanotube array (TNTA) film therefrom. The TNTA film was transferred to a Petri dish containing isopropyl alcohol. This crystalline TNTA film was transferred to a transparent conductive oxide substrate (TCO substrate). In order to strongly fix the TNTA film to a fluorine-doped tin oxide (FTO) film, some droplets of a solution in which titanium butoxide was added to isopropanol were dripped thereon. Last, the TNTA film on the FTO film was heated on a heating substrate at 200° C. for 30 min, and then heated in air at 450° C. for 30 min.

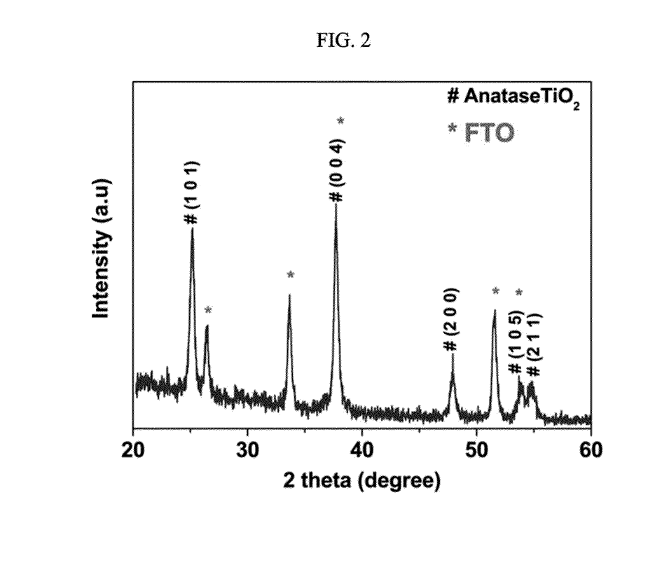

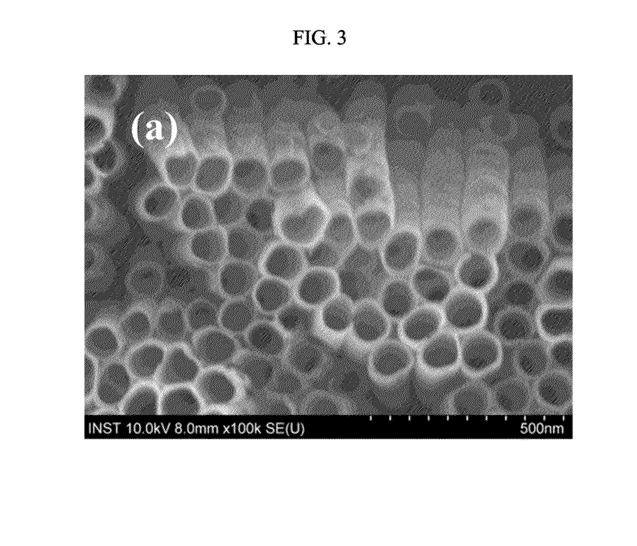

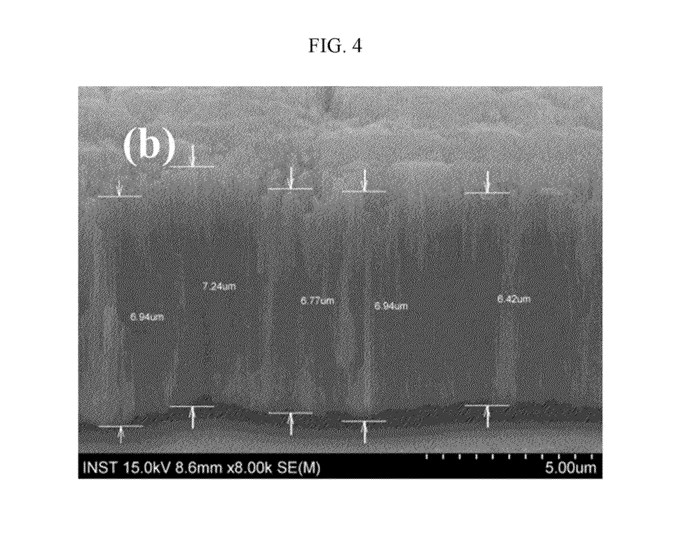

The thus prepared crystalline anatase TiO₂ nanotube array was analyzed through X-ray spectroscopy (XRD), and the resultant graph is shown in FIG. 2. The details will be described in Evaluation Example 1. In addition, the crystalline anatase TiO₂ nanotube array was photographed by scanning electron microscopy (SEM), and the results were shown in FIGS. 3 and 4. The details will be described in Evaluation Example 2.

Coating TiO₂ Layer by Atomic Layer Deposition

A thin amorphous TiO₂ layer of ˜15 nm was coated on the TNTA film on the FTO film by using atomic layer deposition (ALD). Here, the deposition was conducted at 100° C. by remote plasma atomic layer deposition (RPALD) using titanium tetraisopropoxide [Ti(OC(CH₃)₂)₄] as a Ti precursor and O₂ plasma as a reactant.

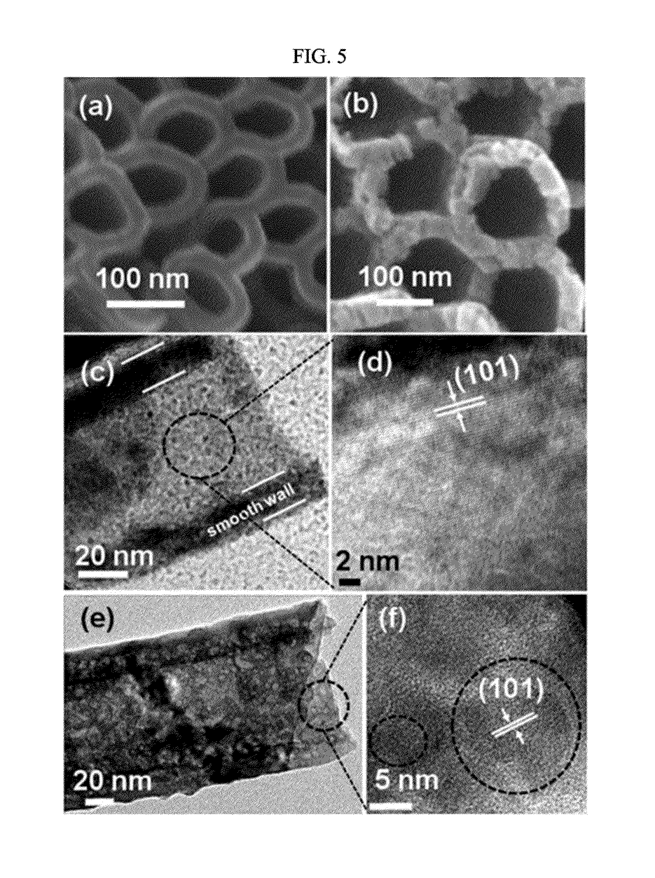

The state in which the TiO₂ layer is coated on the wall surface of the TiO₂ nanotube array by the ALD as described above was observed by high-resolution scanning electron spectroscopy (HR-SEM), and the results thereof are shown in FIG. 5(a). In addition, the state was observed by high-resolution transmission electronic microscopy (HR-TEM) and the results are shown in FIGS. 5(c) and 5(d). The details will be described in Evaluation Example 2.

Water Treatment

After the TiO₂ layer was coated on the wall surface of the TiO₂ nanotube array by the ALD as described above, the resultant structure was immersed in water (watery NH₄F solution) for 24 hours.

The nanotube array after the above water treatment was photographed by HR-SEM, and the results are shown in FIG. 5(b). The details will be described in Evaluation Example 2.

Manufacture of Dye-Sensitized Solar Cell

The thus manufactured TNTA electrode was immersed in a solution, in which 0.3 mM N719 dye (cis-bis(isothiocyanato)bis(2,20-bipyridyl-4,40-dicarboxylato)-ruthenium(II)bis-tetrabutylammonium, Solaronix) was added into a 1:1 (volume ratio) mixed solvent of acetonitrile (Sigma-Aldrich) and t-butanol (Sigma-Aldrich), at room temperature for 18 hours. Then, washing with acetonitrile and drying with nitrogen gas were conducted.

The Pt counter electrode was manufactured by thermal decomposition of a solution in which 0.01 M H₂PtCl₆ (Sigma-Aldrich) was added to isopropyl alcohol (Sigma-Aldrich), and then applied to the FTO film, followed by sintering at 450° C. for 30 min.

Two holes were formed in the Pt counter electrode for electrolyte injection. Spacers were disposed between the TNTA photoelectrode and the Pt counter electrode while Surlyn (25 μm, Solaronix) was used for the spacers. Last, an electrolyte was injected between the spacers through one of the two holes of the Pt counter electrodes, and then the holes were sealed with the Surlyn film and cover glass.

An electrolyte in which 0.5 M 1-methyl-3-propyl imidazoliumiodide (MPII, Sigma-Aldrich) and 0.05 M iodine (Sigma-Aldrich) were added to a solution of 3-methoxypropionitrile (Aldrich) was used for the electrolyte in the example. LiI (Sigma-Aldrich), 4-tert-butylpyridine (Aldrich), and guanidinium thiocyanate (Sigma) were used as an electrolyte additive.

A dye-sensitized solar cell was manufactured by the above method.

### EXAMPLE 2

An electrode and a solar cell including the same were manufactured by the same method as in Example 1, except that the coated nanotubes were immersed in water for 48 hours in the step of water treatment.

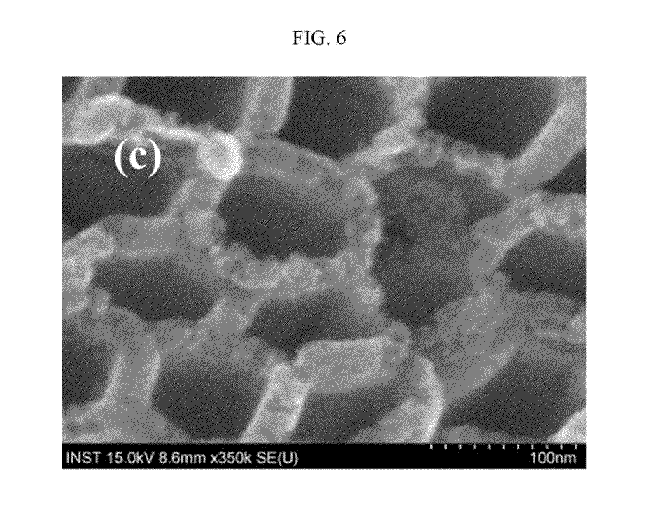

The nanotubes subjected to water treatment for 48 hours in Example 2 above were photographed by HR-SEM, and the results are shown in FIG. 6. In addition, the nanotubes were observed by HR-TEM, and the results are shown in FIGS. 5(e) and 5(f).

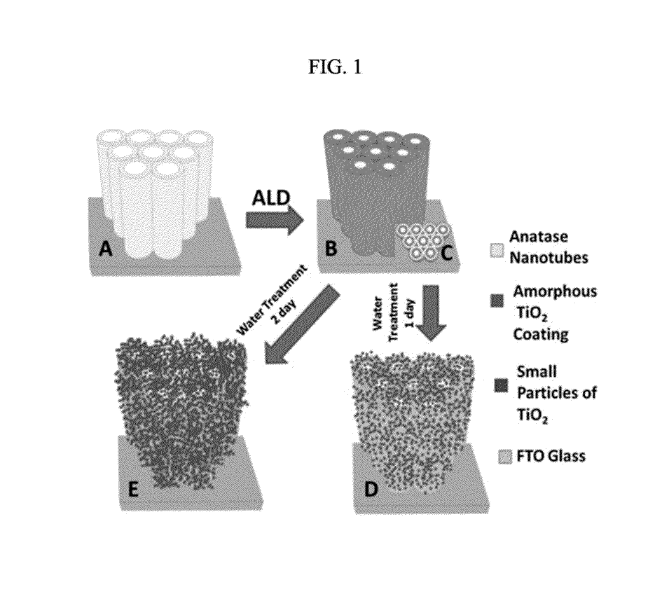

FIG. 1 is a diagram schematically showing a manufacturing method of an electrode according to an embodiment. In FIG. 1, “A” shows anatase TiO₂ nanotubes in formed on an FTO substrate. “B” shows that amorphous TiO₂ coated on wall surfaces of the nanotubes of “A” by atomic layer deposition (ALD). “C” depicts a cross-sectional view of “B”, showing that amorphous TiO₂ is coated on wall surfaces of crystalline TiO₂ nanotubes in yellow. “D” shows an electrode obtaining by subjecting the coated nanotubes to water treatment for 24 hours in Example 1, and “E” shows an electrode obtaining by subjecting the coated nanotubes to water treatment for 48 hours in Example 2. As shown in “D” and “E”, TiO₂ nanoparticles are uniformly formed on the wall surface of the TiO₂ nanotubes through water treatment.

### COMPARATIVE EXAMPLE 1

An electrode and a solar cell including the same were manufactured by the same method as in Example 1, except that a TiO₂ nanotube array subjected to neither ALD nor water treatment was used as an electrode.

### EVALUATION EXAMPLE 1

### XRD Analysis

FIG. 2 is an XRD analysis graph of a crystalline anatase TiO₂ nanotube array before forming the ALD coating layer in Example 1. It can be seen from FIG. 2 that the TiO₂ nanotube array consists of anatase type TiO₂. In the graph of FIG. 2, rutile or brookite type peaks were not observed.

### EVALUATION EXAMPLE 2

### SEM and TEM Image Evaluations

FIG. 3 is an SEM image of a crystalline anatase TiO₂ nanotube array before forming the ALD coating layer. It can be seen from FIG. 3 that the nanotubes are highly arranged and independently arranged. In addition, it can be confirmed that the average outer diameter of the nanotubes was approximately 90 to 110 nm and the average wall thickness thereof was approximately 5 to 7 nm.

FIG. 4 is an SEM cross-sectional image of a crystalline anatase TiO₂ nanotube array before forming the ALD coating layer. It can be seen from FIG. 4 that the average length of the prepared nanotubes is about 7 μm.

FIG. 5(a) is an HR-SEM image of a TiO₂ nanotube array after ALD coating but before water treatment. It can be seen from FIG. 5(a) that the thickness of the coating layer is about 15 nm or smaller. In addition, it can be seen from the comparison between FIG. 3 and FIG. 5(a) that walls of the nanotubes became thicker and the nanotubes were inter-connected.

FIG. 5(c) is a high resolution-transmission electron microscopy (HR-TEM) image of a TiO₂ nanotube array after ALD coating but before water treatment, and FIG. 5(d) is an image of an enlargement of a circled part of FIG. 5(c). The lattice circumference on anatase TiO₂ (101) in FIG. 5(c) is derived from the crystalline TiO₂ nanotube layer.

FIG. 5(b) is an HR-SEM image of the ALD-coated TiO₂ nanotube array after water treatment for 24 hours. It can be confirmed from FIG. 5(b) that the smooth coating layer formed by ALD coating was converted into nanoparticles constituting a rough surface. It is anticipated that the reason is due to a dissolution-precipitation mechanism of the TiO₂ coating layer by water molecules.

FIG. 6 is an HR-SEM image of nanotubes after water treatment for 48 h in Example 2. It can be seen that the surface roughness was further increased as compared with the water treatment for 24 hours since the TiO₂ coating layer was almost reacted.

FIG. 5(e) is an HR-TEM image of a nanotube after water treatment for 48 hours in Example 2, and FIG. 5(f) is an enlarged image of a circled part of FIG. 5(e). It can be seen from FIG. 5(e) that small nanoparticles were formed on internal walls of the nanotube. From the enlarged image of FIG. 5(f), it can be confirmed that the nanoparticles were formed as an island type and partially crystallized.

### EVALUATION EXAMPLE 3

### Evaluation on Photo Conversion Efficiency

In order to evaluate performances of solar cells of Example 1, Example 2, and Comparative Example 1, J-V measurement was employed. Evaluation was conducted with a Newport, USA solar simulator (1000 W Xe source) and Keithley 2400 source meter (device area: 0.25 cm²) under 1 sun illumination (AM 1.5 G, 100 mWcm⁻²) conditions. The intensity of incident sunlight illumination was fixed to a 1 sun condition by using the NREL-certified Si standard cell equipped with the KG-5 filter.

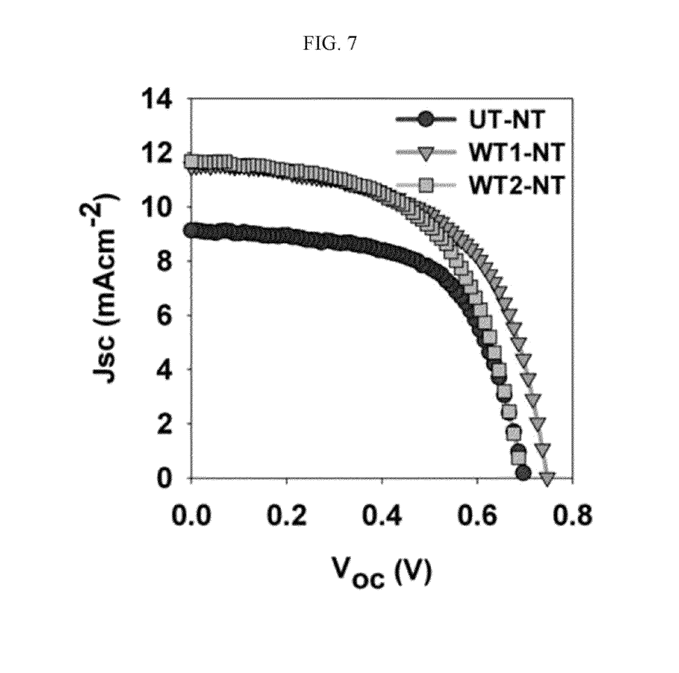

FIG. 7 depicts J-V plots of Example 1, Example 2, and Comparative Example 1, from which current density (Jsc), open circuit voltage (Voc), and photo conversion efficiency were calculated and shown in Table 1. In FIG. 7, UT-NT is for Comparative Example 1, WT1-NT is for Example 1, and WT2-NT is for Example 2.

It can be seen from FIG. 7 and Table 1 that the current density (Jsc) and open circuit voltage (Voc) were further increased, and thus the photo conversion efficiency was further improved in Examples 1 and 2 as compared with Comparative Example 1.

TABLE 1

| | | | | Photo conversion |
|---|---|---|---|---|
| | V_{oc} (V) | J_{sc} (mAcm⁻²) | FF (%) | efficiency (%) |
| Comparative | 0.69 | 9.1 | 61.6 | 3.9 |
| Example 1 | | | | |
| Example 1 | 0.72 | 11.7 | 57.2 | 4.9 |
| Example 2 | 0.68 | 11.9 | 56.7 | 4.6 |

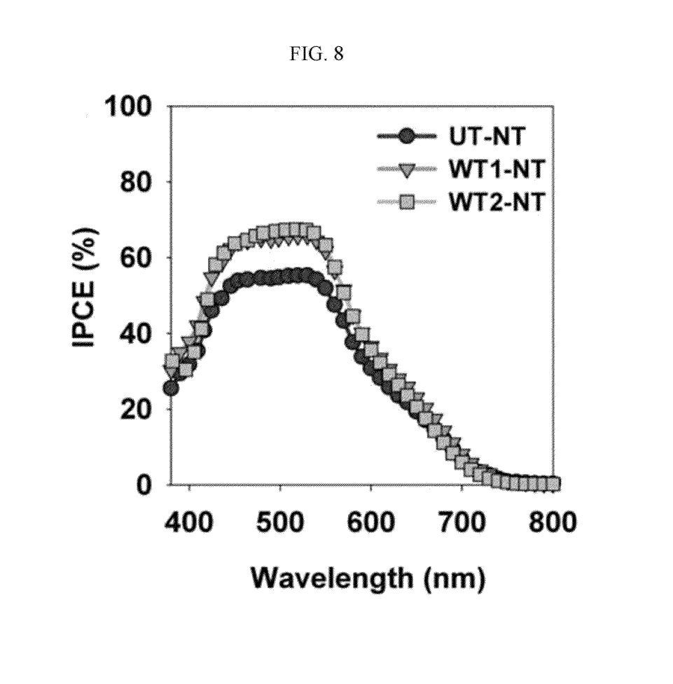

FIG. 8 depicts incident photon-to-current efficiency (IPCE) spectra of Example 1, Example 2, and Comparative Example 1. It can be seen from FIG. 8 that the IPCE was remarkably improved in Examples 1 and 2 as compared with Comparative Example 1.

### EVALUATION EXAMPLE 4

### Lifespan Evaluation

Charge transfer characteristics of the solar cells manufactured in Example 1 and Comparative Example 1 were evaluated by electrochemical impedance spectroscopy (EIS). The results are tabulated in Table 2.

TABLE 2

| | Rₛ (Ω) | Rₚₜ (Ω) | Rₜ (Ω) | R_{rec} (Ω) | η_{col} (%) |
|---|---|---|---|---|---|
| Comparative Example 1 | 9.0 | 6.7 | 6.3 | 21.1 | 0.70 |
| Example 1 | 9.5 | 8.0 | 0.49 | 32.7 | 0.98 |

In Table 2, Rₛ represents series resistance, Rₚₜ represents charge transfer resistance at an interface of the electrode and electrolyte, Rₜ represents transport resistance, R_{rec} represents charge transfer resistance at the interface of TiO₂ nanotubes and the electrolyte, and η_{col} represents column efficiency.

It can be seen from Table 2 that electron conduction characteristics were excellent in Example 1 as compared with Comparative Example 1.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A nanocomposite structure, comprising:
TiO₂ nanotubes; and
nanoparticles comprising titanium or titanium oxide, uniformly disposed on surfaces of the TiO₂ nanotubes

2. The nanocomposite structure of claim 1, wherein the nanoparticles further comprise at least one selected from the group consisting of silver (Ag), silver oxide, gold (Au), gold oxide, platinum (Pt), and platinum oxide.

4. The nanocomposite structure of claim 1, wherein the average outer diameter of the TiO₂ nanotubes is from 10 to 1000 nm.

5. The nanocomposite structure of claim 1, wherein the average wall thickness of the TiO₂ nanotubes is from 0.1 to 100 nm.

6. An electrode comprising a nanocomposite structure, wherein the nanocomposite structure comprises:
TiO₂ nanotubes; and
nanoparticles comprising titanium or titanium oxide, uniformly disposed on surfaces of the TiO₂ nanotubes.

7. An electrochemical device comprising an electrode having a nanocomposite structure, wherein the nanocomposite structure comprises:
TiO2 nanotubes; and
nanoparticles comprising titanium or titanium oxide, uniformly disposed on surfaces of the TiO₂ nanotubes.

8. A manufacturing method of an electrode, the method comprising:
preparing amorphous TiO₂ nanotubes by anodizing a Ti substrate;
crystallizing the amorphous TiO₂ nanotubes through a heat treatment;
bonding the crystallized TiO₂ nanotubes to a substrate; and
forming a coating layer on surfaces of the crystallized TiO₂ nanotubes, through atomic layer deposition (ALD), the coating layer comprising a metal or a metal oxide; and
subjecting the coated nanotubes to a water treatment.

9. The method of claim 8, wherein the crystallizing of the amorphous TiO₂ nanotubes is performed at a temperature of from 200 to 800° C.

10. The method of claim 8, wherein the substrate comprises at least one selected from a transparent conductive oxide (TCO) substrate, a silicon substrate, a plastic substrate, a glass substrate, a metal substrate, a quartz substrate, a metal oxide substrate, and a metal nitride substrate.

11. The method of claim 8, wherein the atomic layer deposition (ALD) is a remote plasma atomic layer deposition (RPALD).

12. The method of claim 8, wherein the atomic layer deposition (ALD) is performed using a metal precursor or a metal oxide precursor, and a plasma.

13. The method of claim 8, wherein the atomic layer deposition (ALD) comprises a remote plasma atomic layer deposition (RPALD) using titanium tetraisopropoxide [Ti(OC(CH₃)₂)₄] as a metal precursor and an O₂ plasma as a reactant.

14. The method of claim 8, wherein the atomic layer deposition (ALD) is performed at a temperature of 70 to 150° C.

15. The method of claim 8, wherein in the forming of the coating layer, the metal is at least one selected from titanium (Ti), silver (Ag), gold (Au), and platinum (Pt), and the metal oxide is at least one selected from titanium oxide, silver oxide, gold oxide, and platinum oxide.

16. The method of claim 8, wherein the thickness of the coating layer is from 1 to 50 nm.

17. The method of claim 8, wherein the coating layer is converted into nanoparticles through the water treatment.

18. The method of claim 8, wherein the water treatment is performed for from 10 to 100 hours.
